(19) United States
(12) Patent Application Publication
(10) Pub. No.: US 2019/0056855 A1
(43) Pub. Date: Feb. 21, 2019

(54) SYSTEM AND METHOD FOR TEMPORAL PLANNING AND MONITORING OF MACHINE STATES

(71) Applicant: SIEMENS AKTIENGESELLSCHAFT, MUENCHEN (DE)

(72) Inventors: MARINA CECCHERINI, GENOVA (IT); TIZIANO FERRANDI, CASTELLDEFELS BARCELONA (ES); DOMENICO GIANNOTTA, GENOVA (IT)

(21) Appl. No.: 16/106,126

(22) Filed: Aug. 21, 2018

(30) Foreign Application Priority Data
Aug. 21, 2017 (EP) 17187024.9

(51) Int. Cl. G06F 3/0484; G06F 3/0482

(52) U.S. Cl. CPC G06F 3/04847; G06F 3/0482

(57) ABSTRACT

A system and a method for planning and monitoring operating states of machines of a plant. A new model for operating states of a machine of a plant is configured within a single graphical editor that is capable of listing states and categories of states for each of the machines of the plant as a function of status-related data generated by the machines. The status-related data is automatically collected from the machine of the plant. The status-related data collected from the machine is automatically matched with the operating states listed in the new model. The operating states of the machine are automatically displayed as a function of the time for a given period of time.

### CROSS-REFERENCE TO RELATED APPLICATION

This application claims the priority, under 35 U.S.C. § 119, of European application EP 17187024.9, filed Aug. 21, 2017; the prior application is herewith incorporated by reference in its entirety.

### BACKGROUND OF THE INVENTION

### Field of the Invention

The invention relates to a method and a system for improving plant efficiency by planning and monitoring plant machine states.

The present invention belongs to the field of Manufacturing Execution Systems (hereafter “MES”). As defined by the Manufacturing Enterprise Solutions Association (MESA International), an MES “is a dynamic information system that drives effective execution of manufacturing operations”, by managing “production operations from point of order release into manufacturing to point of product delivery into finished goods” and by providing “mission critical information about production activities to others across the organization and supply chain via bi-directional communication.”

The functions that MESs usually include, in order to improve quality and process performance of manufacturing plants, are resource allocation and status, dispatching production orders, data collection/acquisition, quality management, maintenance management, performance analysis, operations/detail scheduling, document control, labor management, process management and product tracking.

For example, Siemens Corporation offers a broad range of MES products under its SIMATIC IT® product family.

Within this context, one issue remains the temporal planning and monitoring of states of plant machines in order to improve plant efficiency.

### SUMMARY OF THE INVENTION

It is an object of the present invention to propose an efficient management, namely, planning and monitoring of machine states of each machine of a plant in order to improve the global efficiency of the plant, and to avoid time consuming operations for configuring the machines of said plant.

The objects of the invention are achieved by a novel method and system for planning and monitoring machine states of a plant, which allow an operator to intuitively and simply configure any planning and monitoring of plant machines, notably within a MES, reducing the time necessary to configure a plant and also costs related to operators training.

In other words, the present invention describes a method for planning and monitoring operating states of plant machines, the method comprising:

configuring a new model for operating states of a machine of a plant, in particular of each machine of said plant, within a single graphical editor capable of listing states and categories of states for each of the machines of the plant in function of status-related data generated by the machines. According to the present invention, the configured new model is a hierarchical list of status-related data for the whole set of machines of the plant, said status-related data being typically numerical values outputted by a machine and from which an operating state might be determined according to the present invention;

automatically collecting, preferably in real time, said status-related data from the machine of the plant, in particular of each machine of the plant, and optionally storing said status-related data in a database;

automatically matching, preferably in real time, the status-related data collected from the machine, in particular of each machine, and the operating states listed in the new model;

automatically displaying the operating states of said machine, in particular of each machine, in function of the time for a given period of time, which can be for instance chosen by an operator.

According to the present invention, configuring the new model preferably comprises:

displaying within said single graphical editor a workspace designed for the planning and monitoring of plant machine operating states, wherein the graphical editor is a computer program enabling a creation and/or a reporting of categories of machine operating states, wherein for each category, at least one operating state is configured for defining a working condition of the machine, also called “the status” of the machine at a given time;

creating the new model of operating states for a machine of the plant within said workspace of the graphical editor, wherein the new model is characterized by one or several operating states (or statuses) of the machine, wherein preferably a virtual button on said workspace automatically gives access to categories of operating states, wherein a selection of one of said categories further automatically gives access to lists of operating states for the machine;

selecting an operating state for the machine;

for each selected operating state, automatically displaying on said workspace a graphical object, e.g. a graphical bar, representing the operating state of the machine;

optionally, automatically storing the created new model free of any operator action.

The present invention also concerns a system for planning and monitoring operating states of plant machines, said system comprising:

a user interface configured for displaying a workspace of a graphical editor designed for the planning and monitoring of plant machine operating states;

a processing unit connected to the user interface and to at least one machine of the plant, the processing unit storing instructions for running the graphical editor of the claimed method, the hierarchical list of status-related data of the new model, and being configured for carrying out the steps of the claimed method in order to display the operating states of each of the machines in function of the time for a given period of time by means of the user interface. In particular, the processing unit is configured for automatically saving any new model created by means of the graphical editor and for collecting said data from the machines of the plant, optionally storing said data in a database, and then matching the collected data with the operating states defined in the new model.

Other features which are considered as characteristic for the invention are set forth in the appended claims.

Although the invention is illustrated and described herein as embodied in a system and method for temporal planning and monitoring of machine states, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a schematic representation of a system according to the invention.

FIG. 2 shows a schematic flow diagram of a configuration of a new model according to the invention.

FIG. 3 is a schematic illustration of a graphical representation of the graphical editor according to the invention.

### DETAILED DESCRIPTION OF THE INVENTION

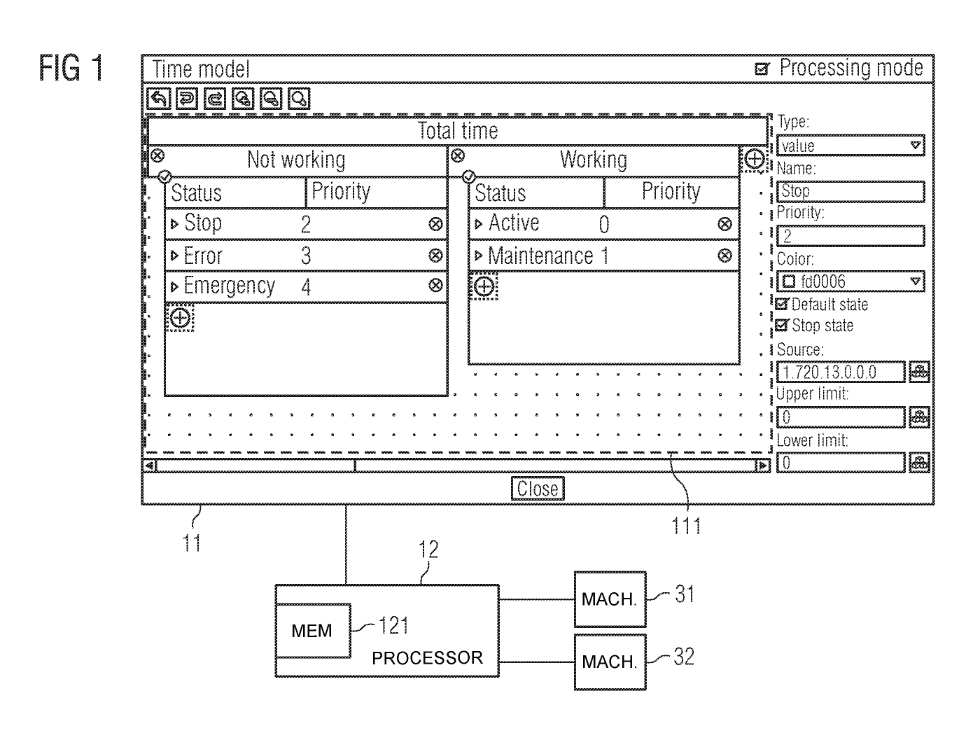

Referring now to the figures of the drawing in detail and first, particularly, to FIG. 1 thereof, there is shown an exemplary embodiment of a system 1 according to the invention. The system 1 comprises, as the main components, a user interface 11 and a processing unit 12.

The user interface 11 comprises a display for displaying a workspace 111 enabling an operator to plan and monitor operating states of one or several machines 31, 32 of a plant, wherein said workspace is a graphical zone on the display that enables a user to create a model of operating states of the machines 31, 32. The graphical user interface (GUI) or graphical editor might be further configured for monitoring, preferably in real time, the operating state of each of the machines of the plant in function of the time, for instance in function of an interval of time defined by an operator.

The processing unit 12 comprises at least one processor and a memory 121. The processing unit 12 is connected to the user interface 11 and to the machines 31, 32 of the plant in order to collect status-related data from the machines 31, 32 in order to monitor in real time of the operating states of said machines. According to the present invention, the processing unit 12 is in particular configured for automatically determining, preferably in real time, the operating state of a machine from the status-related data collected from the machines 31, 32. This determination of the operating state might be performed by comparing the status-related data collected from the machines with the status-related data stored within the new model in order to find which operating state corresponds to the collected status-related data.

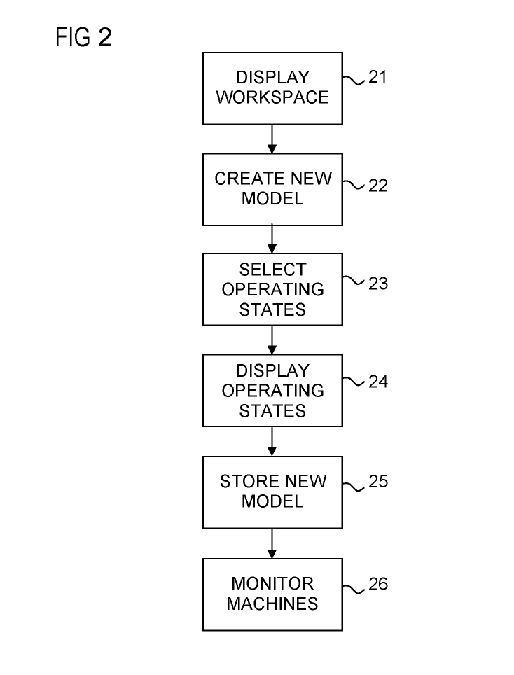

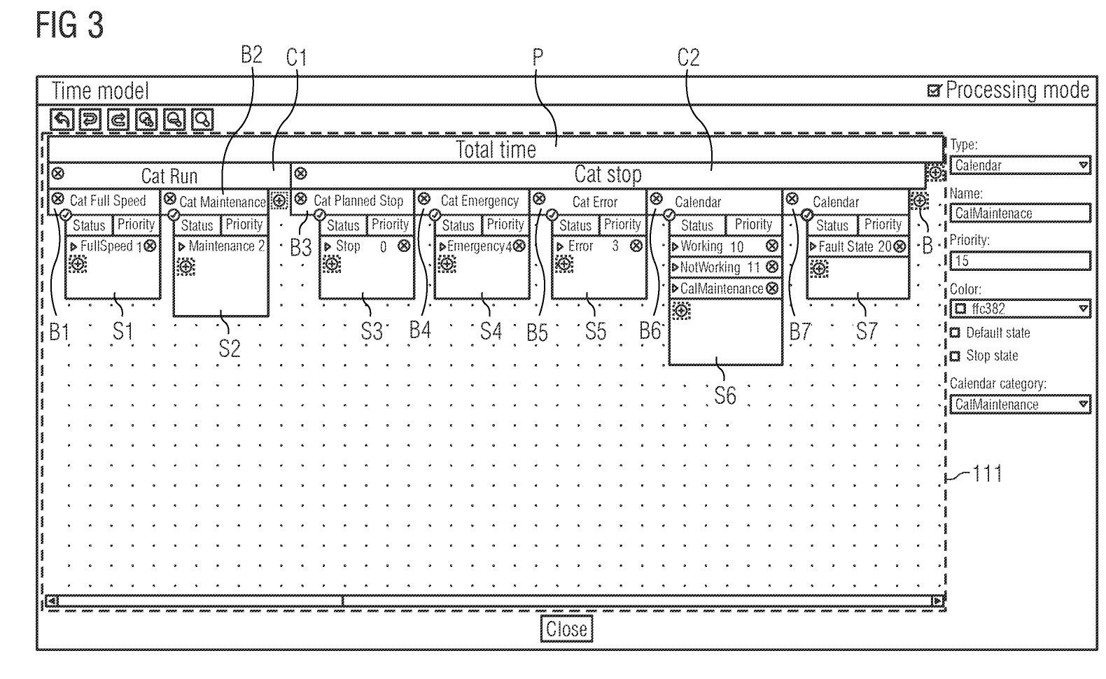

The configuration of a new model according to the invention is schematically represented by FIG. 2, wherein the system according to the invention, in particular its processing unit, is configured for displaying 21, for instance by means of a user interface display, a workspace of a graphical editor, wherein said workspace is designed for enabling an operator to plan and monitor operating states of plant machines. Said workspace 111 is schematically illustrated in FIG. 3 which shows a preferred graphical layout of the graphical editor. Typically, the workspace 111 comprises a virtual button B enabling a user to create a new model for machine operating states. For instance, clicking on said virtual button opens a list of categories of operating states, like the categories “Run” C1, “Stop” C2, “Working”, “Not working”, “Calendar”, “Alarm”, “Full speed”, “Maintenance”, “Planned stop”, “Emergency”, “Error”, “Fault”. For each category and at each selection of a category by an operator, the graphical editor automatically provides a list of operating states S1, S2, S3, S4, S5, S6, S7 that can be preferably defined as row value, bit value, range of values, alarm category or linked to a calendar category that might be generated or outputted by a machine of the plant. Advantageously, the list of categories and operating states can be limitlessly extended by an operator in order to match operating states of machines of the plant. Examples of operating states are for instance:
“Stop”, “Error”, or “Emergency” for the category “Not working”;
“Shift”, “Working week”, “Fiscal year” for the category “Calendar”;
“Active”, “Maintenance” for the category “Working”;
“Fullspeed 1”, “Fullspeed 2” for the category “Fullspeed”.

For each operating state that has been selected within a category, the graphical editor of the system according to the invention enables the operator to define a priority, color, and information, as parameters for the operating states.

Using the graphical editor, the operator can easily create 22 a new model of operating states for a machine of the plant wherein all information regarding the operation of the machine are available within a single view, i.e. within said workspace of the graphical editor. The new model is characterized by different operating states S1, S2, S3, S4, S5, S6, S7 (or statuses) of the machine defined for different operating states categories of the machine that might occur during a working process P of the machine, wherein each operating state may comprise or define further information or parameter related to the operation of the machine, so that an operating state of the machine might be determined from status-related data outputted by the machine and collected by the processing unit.

The individual operating states may be selected 23. That is, the system enables the user to select 23 an operating state for the machine for a category of operating states.

Advantageously, for each selected operating state, the system according to the invention automatically displays 24 on said workspace 111 a graphical bar B1, B2, B3, B4, B5, B6, B7, representing the operating state of the machine. According to the claimed method, the system automatically stores 25 the created new model in the memory 121 free of any operator action. Additionally, the graphical editor further provides commands for helping model creation, like a resetting function enabling the model to return to an initial state, an undo/redo function enabling to reorder a step and navigate backward and forward within the steps, a zoom in/out function facilitating reading information of the created model like operating states of the machines, a reset zoom function which is configured for setting the zoom level in such a way that the entire created model appears in the user interface display, and a expand all/collapse all function configured for expanding or closing all categories and statuses.

According to a preferred embodiment, the method according to the invention further comprises an interaction 26 of the processing unit with the machine in order to collect status-related data from the machines. It enables the system according to the invention to provide an operator with a monitoring of operating states of the machines in function of the time from matching status-related data collected outputted by the machine and status-related data stored within the operating states defined for said machines in the created model.

1. A method for planning and monitoring operating states of machines of a plant, the method comprising:
configuring a new model for operating states of a machine of a plant within a single graphical editor that is configured to list states and categories of states for each of the machines of the plant in dependence on status-related data generated by the machines;
automatically collecting the status-related data from the machine of the plant;
automatically matching the status-related data collected from the machine and the operating states listed in the new model; and
automatically displaying the operating states of the machine as a function of time for a given period of time.

2. The method according to claim 1, wherein the step of configuring a new model comprises:
displaying within a graphical editor a workspace designed for the planning and monitoring of plant machine operating states;
creating a new model of operating states for the machine of the plant within the workspace of the graphical editor, wherein the new model contains one or a plurality of operating states of the machine;
enabling a selection an operating state for the machine for a category of operating states; and
for each selected operating state, automatically displaying on the workspace a graphical object representing the operating state of the machine.

3. The method according to claim 1, which comprises providing a virtual button on the workspace to automatically enable access to categories of operating states, wherein a selection of one of the categories further automatically enables access to lists of operating states for the machine.

4. A system for planning and monitoring operating states of a machine of a plant, the system comprising:
a user interface for displaying a workspace of a graphical editor designed for the planning and monitoring of plant machine operating states; and
a processing unit connected to said user interface and to at least one machine of the plant, said processing unit having a memory configured for storing instructions for running the graphical editor and said processing unit being configured for carrying out the method according to claim 1.
